(19) United States
(12) Patent Application Publication
(10) Pub. No.: US 2017/0265492 A1
(43) Pub. Date: Sep. 21, 2017

(54) Tools and Methods for Making Edible Gelatin Art

(71) Applicant: Dan Cohen, Sun Valley, CA (US)

(72) Inventor: Dan Cohen, Sun Valley, CA (US)

(21) Appl. No.: 14/765,119

(22) PCT Filed: Jun. 24, 2015
(86) PCT No.: PCT/US15/37438

§ 371 Date: Jul. 31, 2015

Related U.S. Application Data
(60) Provisional application No. 62/094,307, filed on Dec. 19, 2014.

(51) Int. Cl. A23G 3/28; A23L 29/281; A23G 3/34

(52) U.S. Cl. CPC A23G 3/28; A23G 3/0097; A23L 29/284; A23V 2002/00

(57) ABSTRACT

The subject matter herein generally relates to materials and methods for producing three-dimensional colored shapes within clear gelatin. According to preferred embodiments, the tools and methods of the present invention are used for making edible gelatin art.

### BACKGROUND

There is a tremendous interest in three-dimensional tools for creating “Gelatin Art.” With significant commercial interest, there is a significant and unmet need for improved tools, techniques and methods for producing three-dimensional colored shapes within clear gelatin.

### SUMMARY

According to one embodiment, a tool for producing edible gelatin art comprises a gelatin art creation component and a needle component, wherein the gelatin art creation component is attached to the needle component.

According to another embodiment, the gelatin art creation component comprises a stainless steel component.

According to another embodiment, the gelatin art creation component is soldered to the needle component.

According to another embodiment, the needle component comprises a hydroponic needle.

According to another embodiment, the needle component is further attached to a syringe.

According to another embodiment, the syringe is selected from the group consisting of a monoject syringe and a leur lock disposable syringe.

According to another embodiment, the needle component is further attached to a leur lock cap/bottle.

According to another embodiment, a process for making a tool of the present invention comprises shaping the gelatin art creation component, and attaching the gelatin art creation component to the needle component.

According to yet another embodiment, a process for making a tool of the present invention further comprises soldering the gelatin art creation component to the needle component.

According to yet another embodiment, a process for making a tool of the present invention further comprises polishing the gelatin art creation component.

According to yet another embodiment, a method of producing edible gelatin art comprises use of the tool for producing edible gelatin art.

According to yet another embodiment, the edible gelatin art comprises one or more three-dimensional colored shapes comprising clear or substantially clear gelatin.

### DESCRIPTION OF PREFERRED EMBODIMENTS

The subject matter of the present invention relates to materials and methods for producing three-dimensional colored shapes within clear gelatin. According to preferred embodiments, the tools and methods of the present invention are used for making edible gelatin art. The present invention contemplates a number of different embodiments. Certain representative embodiments are described herein and do not limit the scope of the invention in any way. It will be understood by those of ordinary skill in the art that further alterations and modifications are also included within the scope of the invention. Those skilled in the art will recognize additional features and advantages upon reading the description herein, and upon viewing the accompanying figures.

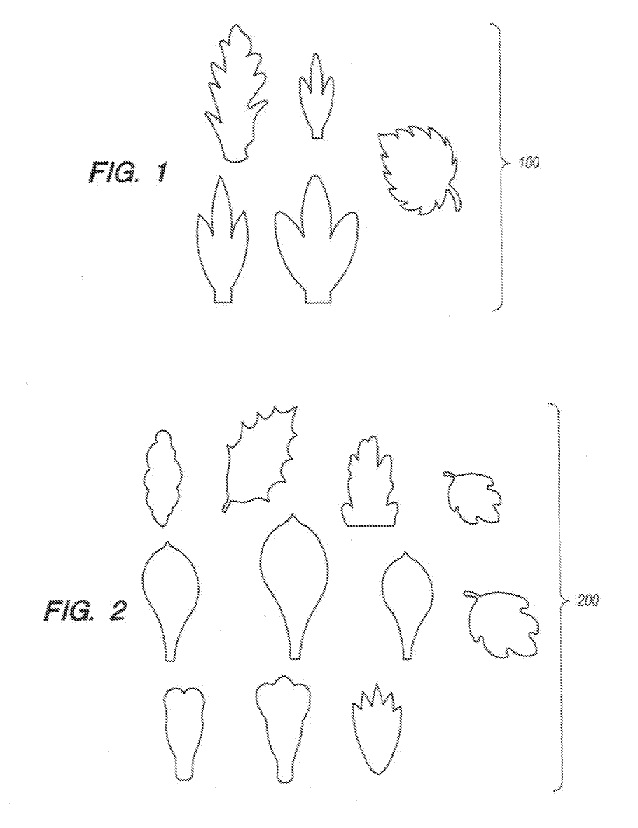

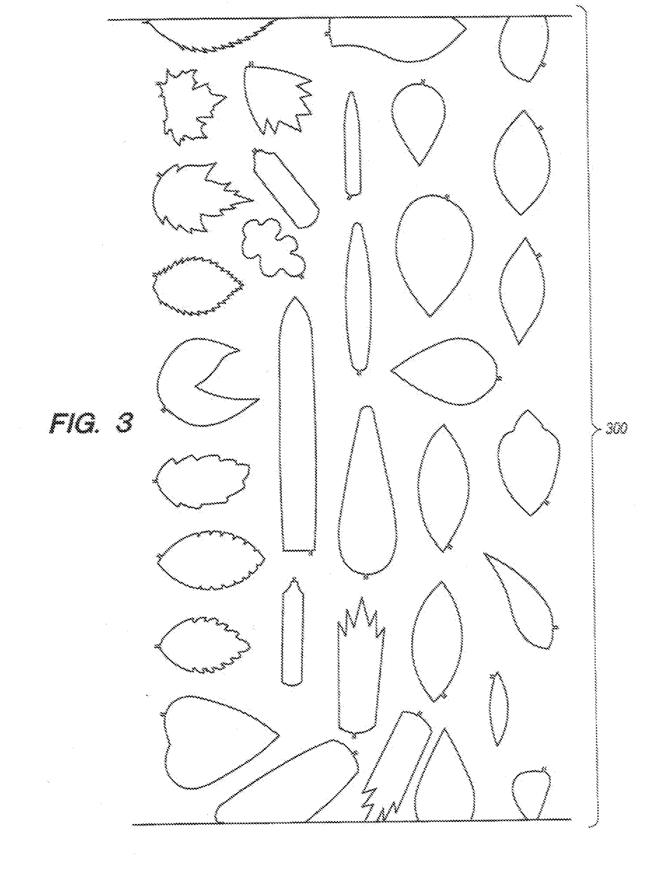

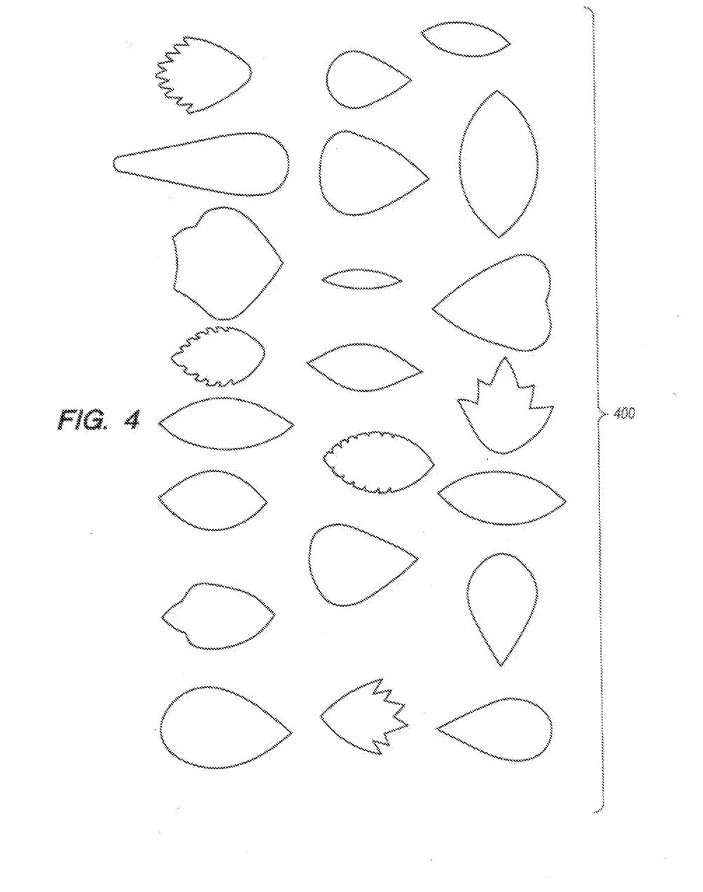

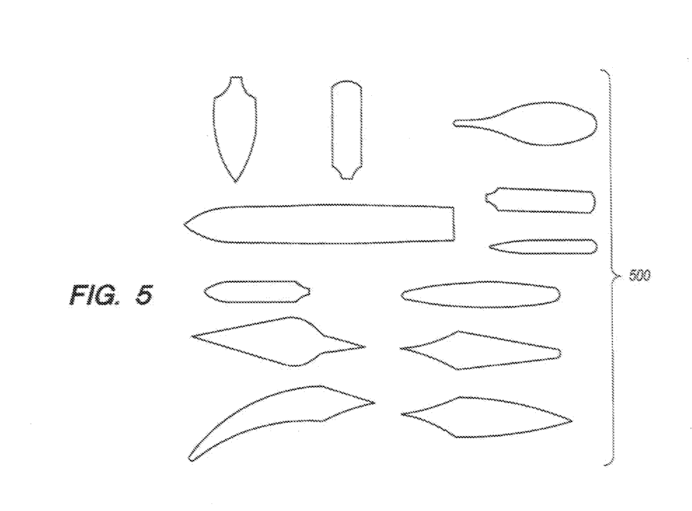

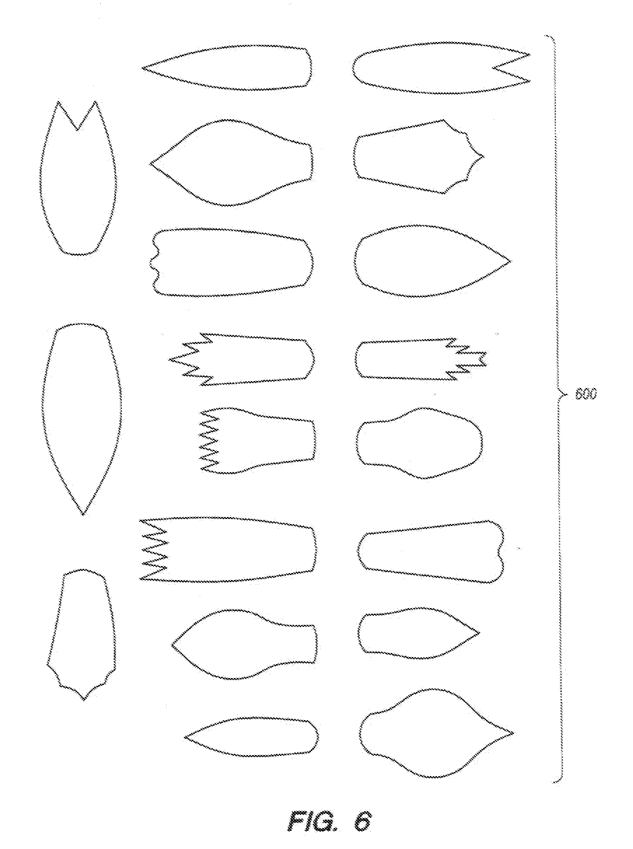

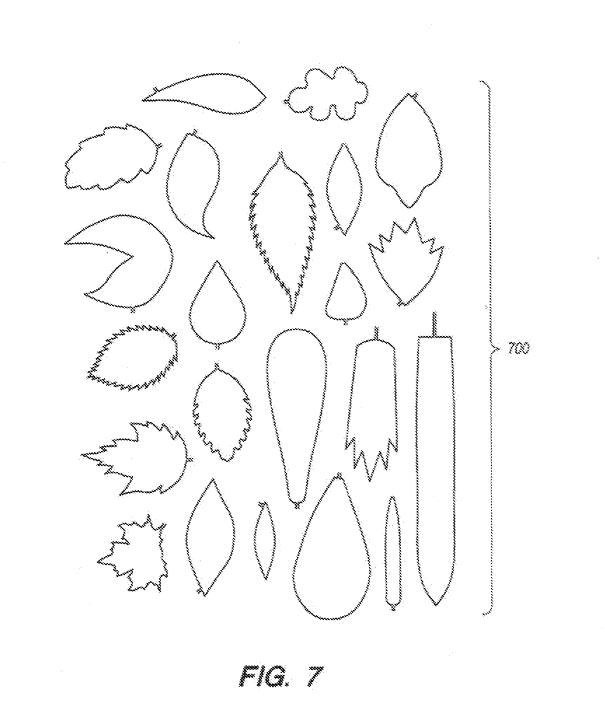

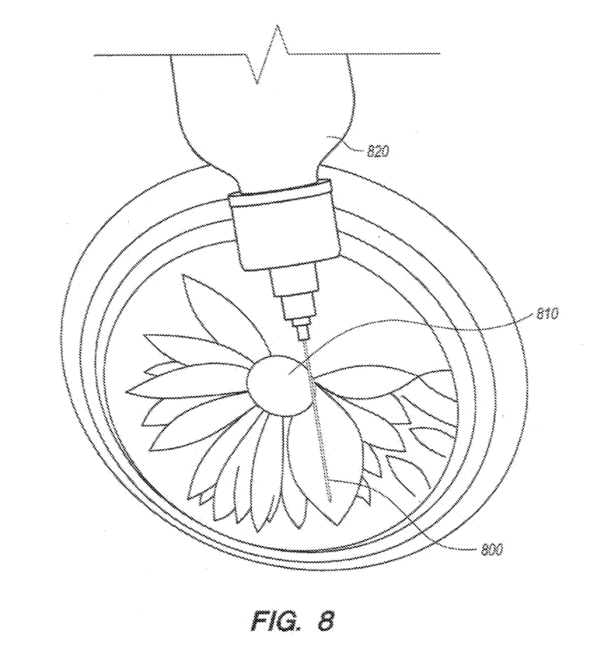

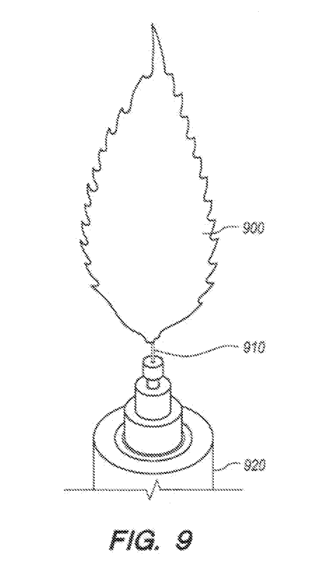

The term “gelatin art creation component” of the tools of the present invention, as used and described herein, is understood to refer to any component that can be cut, shaped, or otherwise designed for making edible gelatin art, such as for example the stainless steel component 800 as shown and depicted in FIG. 8, or the stainless steel component 900 as shown and depicted in FIG. 9. The “gelatin art creation component” may be designed to have any desired shape. For instance, any one of the different representative shapes 100-700 displayed in FIGS. 1-7 can be used by a sheet metal company for manufacturing and creating the “gelatin art creation component” of the tools of the present invention for making edible gelatin art.

The term “needle component” of the tools of the present invention, as used and described herein, is understood to refer to any needle component, such as for example a hydroponic needle, or the needle component 810 as shown and depicted in FIG. 8, or the needle component 910 as shown and depicted in FIG. 9.

According to a preferred embodiment, one or more tools of the present invention can be used to create three-dimensional (3D) edible gelatin and gelatin-based art, including three-dimensional colored shapes using clear or substantially clear gelatin. The 3D art preferably includes edible gelatin and gelatin-based foodstuffs including, for example, edible gelatin and gelatin-based desserts. The clear gelatin or gelatin-base can be enhanced with different flavors.

“Gelatin” as used herein refers to an essentially translucent, colorless and tasteless foodstuff, and which can be used as a gelling agent in food preparation. The gelatin used in accordance with the present invention can be made, for instance, using any suitable form of gelatin powder, e.g., in the form of granules, pure powder, or essentially pure powder. “Gelatin-base” as used herein is intended to refer to any composition that includes primarily gelatin, and which may contain one or more other edible ingredients mixed with gelatin. To make clear gelatin, or substantially clear gelatin, any number of suitable gelatin powders can be mixed with water, e.g. distilled water, and allowed to stand for several hours. Preferred gelatin powders are pure protein powders. Gelatin powder can also be dissolved in hot water, and then cooled to form the gel-like gelatin. One or more other ingredients can also be added when making the gelatin. Such ingredients include, for example, citric acid, sweetener and one or more flavors.

The tools described herein, for use in accordance with the present invention, can also be referred to as 3D gelatin art tools, otherwise referred to as Gubia Aguja, and Gurbias. The tools, i.e. Gurbias, are preferably made from FDA-approved metals that are safe and approved for use in making foodstuffs (including edible gelatin art) for human consumption. One example of such FDA-approved metals includes food-grade stainless steel. The tools described herein, for use in making 3D gelatin art, can be made of any suitable material or combination of FDA-approved materials. According to a preferred embodiment, food-grade stainless steel is cut and formed into tools of various shapes. “Food-grade” stainless steel tools are also understood to be safe, i.e. safe in terms of coming into contact with gelatin and other ingredients when used in preparing edible gelatin art. Food-grade stainless steel tools can be cut and manufactured, for instance, by a sheet metal company. A sheet metal company can use various art work or templates to cut materials and make the tools. The art work can include art of any suitable size and shape as desired for making the tools. FIGS. 1-7 display a number of different representative shapes 100-700 that can be used by a sheet metal company for cutting tools to form 3D gelatin art tools. These representative shapes illustrate the different types of shapes that can be used for making the 3D gelatin art tools, in accordance with the invention. The various shapes depicted in FIGS. 1-7 are for illustration purposes only, and it is to be understood that any shape art work can be used for cutting tools to make 3D gelatin art tools or Gurbia.

According to a preferred embodiment, once a stainless steel tool, i.e. a tool used for creating and producing 3D edible gelatin art, is cut and formed, it can be polished, cleaned, and then soldered onto a hydroponic needle, metal needle or other suitable type needle. The assembled unit can then be screwed onto a syringe or a leur lock cap/bottle, such as the bottle 820 shown in FIG. 8, or leur lock cap/bottle 920 shown in FIG. 9.

Certain preferred embodiments of process steps are described herein in more detail, by way of illustration. When the stainless steel tool is polished, any suitable polishing technique can be used. Polishing, in accordance with the invention, can involve any process of creating a smooth surface of the stainless steel tool. The stainless steel tool can be rubbed using a non-abrasive cloth, for example. The stainless steel tool can also be polished using any suitable chemical action that does not damage the stainless steel surface.

When a stainless steel tool is soldered onto a hydroponic needle, metal needle or other suitable type needle, any suitable technique can be used for soldering. Different methods, temperatures, timing, etc, can produce the desired result for soldering a stainless steel tool onto a suitable type needle. For instance, iron tip/contact soldering, laser soldering, and ultrasonic soldering techniques can be used. Iron tip/contact soldering provides high quality. According to the present invention, the quality, strength, integrity and durability of the 3D gelatin art tools is very high because impurities are essentially entirely absent from the soldering process.

In accordance with the present invention, one example of a suitable soldering process is described in more detail. A soldering bonding process can be used, and begins when flux is used to remove oxide layer from the substrate. The bond is then formed by “wetting”, “melting”, and “spreading” on the interface between the substrate and the solder. In accordance with the present invention, the melting and spreading processes result in the formation of an intermetallic bond in the solder. The molten solder expands onto the metallic surface from which the oxide layer was removed, and the substrate metal melts into the solder material. Such a soldering process can be reliably and efficiently used for soldering a stainless steel tool onto a suitable type needle.

Since the tools of the present invention are used for making 3D edible gelatin art, lead-free solder is used. Also, as described herein, when food-grade stainless steel is used, the stainless steel is an FDA-approved metal that contains no lead. This assures the safety of the tools for making gelatin-based edible art and foodstuffs for human consumption.

As further described herein, the assembled unit, e.g. a tool (used for making 3D edible gelatin art) that has been formed, polished, cleaned, and soldered onto a hydroponic needle, can then be screwed onto a syringe or a leur lock cap/bottle. Different types of leur lock cap/bottles and leur connectors can be used for the invention. For instance, Luer Slip connectors, Luer Lok or Luer Lock connectors can be used. Luer Lock connectors comprise a Luer Slip center tip surrounded by a screw locking thread. The two parts are twisted together and the screw thread prevents the Luer Slip connector from coming off. This configuration greatly reduces and essentially eliminates leakage. The tools, according to the present invention, when designed for making 3D edible gelatin art, are designed such that they provide essentially leak-free fluid connections. The assembled units can reliably and efficiently be used for making three-dimensional colored shapes within clear gelatin or within a gelatin-base.

Different types of syringes can also be used with the invention. Examples of syringes include, but are not limited to, monoject syringes (for instance, luer lock and catheter tip, anticoring polypropylene, aluminum hub monoject syringes); and luer lock disposable syringes (for instance, 3 cc, 5 cc, 10 cc, 20 cc, 30 cc, 60 cc, or 1 mL size syringes). A syringe can have any desired tip on the end of the syringe; different tip designs can be utilized. In one embodiment, tools used for 3D edible gelatin art can be manufactured and assembled with a small connection known as slip tips which are useful when a syringe is connected without a screw lock mechanism.

In another embodiment, a catheter tip can be used, which is similar to a slip tip but is instead longer arid tapered, and is surprisingly beneficial because the plastic taper can form a tight seal.

In yet another embodiment, an eccentric tip can be used, in which the outlet at the end of the syringe is not in the center of the syringe but is positioned at the side of the syringe.

As described herein, according to a preferred embodiment, once a stainless steel tool, e.g. a tool used for making 3D edible gelatin art, is cut and formed, it can be polished, cleaned, and then soldered onto a hydroponic needle, metal needle or other suitable type needle. The assembled unit can then be screwed onto a syringe or a leur lock cap/bottle. One example of such an assembled unit, in which a stainless steel tool is cut and formed, polished, cleaned, soldered onto a metal needle, and then screwed onto a bottle, is depicted in FIG. 8. Another example of such an assembled unit is depicted in FIG. 9.

As described herein, the term “gelatin art creation component” of the tools of the present invention is understood to refer to any component that can be cut, shaped, or otherwise designed for making edible gelatin art, such as for example the stainless steel component 800 as shown and depicted in FIG. 8, or the stainless steel component 900 as shown and depicted in FIG. 9. The “gelatin art creation component” may be designed to have any desired shape. For instance, any one of the different representative shapes displayed in FIGS. 1-7 can be used by a sheet metal company for manufacturing and creating the “gelatin art creation component” of the tools of the present invention for making edible gelatin art.

Also, as described herein, the term “needle component” of the tools of the present invention is understood to refer to any needle component, such as for example a hydroponic needle, or the needle component 810 as shown and depicted in FIG. 8, or the needle component 910 as shown and depicted in FIG. 9.

The tools of the present invention can also be manufactured using, for example, robotic instruments and/or 3D printing for both manufacturing the tools and creating an edible product. Three-dimensional printing (3D printing) is a preferred method for manufacture and production of the tools of the present invention. For example, with regard to making an edible product, three-dimensional models stored on a computer can be relayed to a printer, which can be used to make different amounts and variations of an edible product such as a dessert. Alternatively, robots equipped with the tools of the present invention and also equipped with consumable gelatin can be used to carve patterns in the gelatin. Robotic instruments and 3D printing can also be used, for example, on a regular 24-7 production cycle. Both methods can also be used with essentially no human interaction which also decreases contamination and costs.

According to yet another preferred embodiment, plastic mold injection, or other suitable processes, can be used for forming and manufacturing tools of various shapes. According to preferred embodiments of the invention, any type of suitable rapid injection molding, rapid injection tooling, custom injection molding, or plastic injection molding can be used to form the 3D gelatin art tools. Overmolding processes can also be used, e.g., where one thermoplastic material is molded over another material to form one part of a tool. All the materials used are FDA-approved as safe. If it is desired to use overmolding to form the 3D gelatin art tools, soft thermoplastic materials can be overmolded to hard plastic. Any type of suitable molding process can be used in accordance with the present invention to create desired 3D gelatin art tools. The tools that are made, in accordance with the present invention, for use in creating 3D edible gelatin art, can also have any suitable dimensions, thickness, shape and size, as needed or desired. Examples of shapes of the tools include, but are not limited to, petals and leaves. Tools can also be formed in any other desired shape including, for example, a circle, square, triangle, rectangle, pentagon, hexagon, snowflake shapes, octagon, decagon, nonagon, trapezoid, parallelogram, rhombus, heptagon, star, crescent, oval, semicircle, cylinder, prism, and pyramid, just to name a few examples. According to one example, clear gelatin, or substantially clear gelatin, or any gelatin-base composition, can be prepared in a mold or other solid container. The mold can include, for example, any hollow form or hollow container that can be used for giving a particular shape to the edible gelatin or gelatin-based art. When the gelatin is firm, the mold can be turned over. After the mold is turned over, the gelatin can be removed and the tools of the present invention can be used to create 3D gelatin art, including colored shapes within clear gelatin. With a variety of tools or styluses, one can etch or cut different patterns and shapes into gelatin or a gelatin- base, and make any number of desired shapes in the gelatin or gelatin-base, to create 3D gelatin art or gelatin-based art. The shapes in the gelatin or gelatin-base can include, for instance, flower petals, leaves and a stamen. It is to be understood that any shape can be formed in the gelatin or gelatin-base. Other representative examples of shapes or combinations of shapes that can be formed in the gelatin or gelatin-base include, for instance, one or more of a combination of any of the following shapes in any orientation: circle, square, triangle, rectangle, pentagon, hexagon, snowflake shapes, octagon, decagon, nonagon, trapezoid, parallelogram, rhombus, heptagon, star, crescent, oval, semicircle, cylinder, prism, and pyramid, just to name a few examples. According to other exemplary embodiments, there can be any pattern or variety of patterns, of any size and shape desired, that are formed within the 3D gelatin art.

The present invention can be used to make any kind of 3D edible gelatin art. Representative examples include edible gelatin art cake and other types of edible gelatin desserts. The edible gelatin desserts may be in the form of fruit, flowers, or any other shape. After an edible gelatin dessert or other type of gelatin art is formed, other modifications, additions, and features may be added to the gelatin art as desired. For instance, with bright, edible, milk-based gelatin, one or more different colors can be inserted into the gelatin art. In a preferred embodiment, edible coloring agents can be used for adding one or more colors to the gelatin art. Depending on the type of gelatin art, the color or colors may be inserted with a syringe, eyedropper, metal star tip, or other suitable instrument. The colors may also be used to form other shapes, for instance shapes of animals, into the gelatin art.

It is to be understood that the tools of the present invention are surprisingly useful for creating a wide variety of three-dimensional edible gelatin art. According to one example, the tools of the present invention can be used for making 3D gelatin art flower shape designs in gelatin or a gelatin-base. According to the present invention, it has been surprisingly discovered that the tools of the present invention are very useful and beneficial for creating unique angles and spaces within the gelatin art. It has been surprisingly discovered that it is very beneficial to insert a tool in a certain manner to form a desired shape, for instance, to form a circle. By way of example, an exemplary process for creating one or more shapes in a gelatin mold is described herein. When one has a clear gelatin mold, a dot can be marked on a paper towel, and then the clear mold can be placed to mark the center. To create a flower shape, a melon bowler can be dipped in hot water. The melon bowler can be leaned on the edge of the dome making sure it penetrates about one-third into the mold, and not too deep to avoid altering the shape of the flower. The mold can be rotated, for instance, a full 360 degrees. One or more tools, e.g. cutting tools, in accordance with the invention, can be chosen and attached to a bottle or a syringe, as described herein. To make pistils on the flower shape, a drawing can be prepared, and then a needle can be inserted at about 90 degrees then the angle can be changed while still penetrating the mold, and while rotating the mold, to create the shape of the pistils. For the first row of petals of the flower shape, a spoon or other tool (Gurbia) can be inserted right above the pistils making sure the angle and space is the same each time. By following the drawing and rotating to the left each petal, the tool can be used to form each petal. A second row and third row of petals can be created by inserting the spoon or other tool at a desired angle. A pattern of leaves on the flower shape can also be created using the tools of the present invention. The gelatin ball can be placed back into the mold.

In accordance with the present invention, it has been surprisingly found that some food colors may have a bitter aftertaste, and one can neutralize them with sugar or other food flavor. It is preferred in many instances, when using unflavored gelatin, that it should be at least 275 bloom or the gelatin will be cloudy. It has also been observed that the texture and consistency of the gelatin may vary depending on the room temperature, and thus the room temperature may be adjusted as needed or desired to maintain gelatin with desired texture and consistency. It has also been surprisingly observed that the texture and consistency of the gelatin can be improved by removing air bubbles from the gelatin. Also, clear gelatin should be sprinkled over water and mixed well. When mixed with other ingredients, clear gelatin should be strained to avoid lumps. Moreover, it has been surprisingly observed that white gelatin should be blended, e.g., in an electric blender to merge the titanium dioxide with all ingredients. To speed the setting process for a gelatin mold, the gelatin can be placed in freezer for approximately five minutes or in an ice filled bowl. It has also been observed that it is advantageous not to use fruits such as kiwi, pineapple, or other fruits that contain enzyme, because they will dissolve and liquify the gelatin. When using strawberries, it is desired to blot with a paper towel to absorb; and the same process can be used for canned pineapple.

Other surprising steps and processes that have been discovered, and which are within the scope of the present invention, and which confer numerous advantages for making 3D edible gelatin art, include the following:
Store ready gelatin in a chilled environment to prevent softening.
Store gelatin powder in a closed container.
Make sure gelatin is completely dissolved before adding other liquids.
For faster setting, use a metal mold
Freezing will retain the shape of the mold but change the texture to a rubbery like form.
Add a pinch of edible glitter for more shine.
If your gelatin becomes translucent, it means the gelatin is hot or you may need to add titanium.

### EXAMPLE

One representative process for manufacturing tools of the invention is described in this example. A 4′×10′ food grade stainless steel (26 gauge type 3042B) sheet of metal is placed on a water jet cutting machine. Templates for the design, including shape and size, as well as quantities are programmed into the machine's software. Once programmed, the machine water cuts the pieces to the desired specification, leaving them partially intact onto the sheet of metal. Once the pieces are cut, they are delivered to a facility. Individual (flat) pieces are removed from the sheet by hand. Individual (flat) pieces are then bent into various shapes, depending on the piece, by hand in a sheet metal “slip roll.” Cut and rolled pieces are then assembled according to the following steps and procedures:
cut and rolled piece is brushed with acid (Johnson's #1 stainless steel flux) to prepare for soldering.
a syringe is soldered onto the piece with STEL-FLO Lead-Free Tri-Bar SOLDER.
soldered assembly is left to dry.
assembled piece is buffed and polished using Mothers Mag & Aluminum polish and Warrier (item 69700) 6″ Spiral Buffing Wheel.
buffed and polished piece is then thoroughly washed with hot water and dish washer soap and set to dry.
completed pieces are set in boiling water for final cleansing, then set to dry.
completed pieces are ready for sale.

### Example of a Clear and White Gelatin Recipe

Clear Gelatin
1 cup water at room temperature
4 Tbs Gelatin
3 cups water at room temperature
1 ½ cups sugar
½ teaspoon citric acid
Food flavor

Sprinkle gelatin over 1 cup water, stir and set aside about 5 minutes. Liquify in microwave for 45 seconds. Dissolve sugar in 3 cups of water then add citric acid, flavor and melted gelatin. Place a thick paper towel in strainer and strain gelatin to clear or set aside at room temperature for about 30 min to clear. Pour into mold and chill until set (e.g., about 8 hours)
White Gelatin
1 cup water at room temperature
3 cups water at room temperature
8 Tbs. powder milk
1 1/2 cups sugar
Food flavor
1 Tbs. Titanium dioxide
2 1/2 Tbs. Gelatin

Sprinkle gelatin over 1 cup water stir and set aside to bloom, about 5 minutes. Liquify in microwave for 45 second. Dissolve sugar in 3 cups water, add powder milk, titanium dioxide, food flavor and melted gelatin and blend in a blender for about 2 Minute. Add good colors.

White Gelatin with Condensed Milk
1 can Condense Milk
1 ½ cups water
2 ½ tbs gelatin bloom in an additional cup of water
1 tbs TitaniumDioxide
flavor

Sprinkle gelatin over 1 cup water stir and set aside to bloom, about 5 minutes. Liquify in microwave for about 45 seconds. Combine milk, water, titanium dioxide, food flavor and melted gelatin and blend in a blender for about 2 minutes. Add good colors.

### Milk Base for Picture Transfer

2 cups water
3 tbs gelatin
1 can condensed milk flavor
bloom gelatin in ½ cup of the water and hydrate in 15 second increments combine with water, milk and flavor, mix well.

### Other Examples of Edible Gelatin Art

Cheese cake base for gelatin flower
3 cups sour cream
1 cup heavy whipping cream
½ cup sugar
1 pack instant pudding
Melt 2 tbs gelatin in ½ cup water
Lemon zest
Whip cream with sugar then mix all, pure over gelatin and chill
Fruit Pudding (any fruit, but no fresh pineapple or kiwi )
Fruit puree 450 g (15.9 oz.)
Lemon juice 30 g (1.1 oz.)
Sugar 70 g (2.5 oz.)
Gelatin 1 Tbs
Heavy whipping cream 170 g (6.0 oz.)
Milk 70 g (2.5 oz.) bloom gelatin in 5 tbs water. Put the fruit puree on heat and simmer for a short moment. Then take away from the heat and mix in the lemon juice. Add the sugar and mix until it completely dissolved. Hydrate gelatin and mix it into the fruit puree. Strain the puree through a sieve to remove any remaining lumps of gelatin. Mix in the heavy cream and the milk. Fill the mold cover put in the fridge until the cream firms. This can take several hours, (overnight).

What is claimed:

1. A tool for producing edible gelatin art, comprising a gelatin art creation component and a needle component, wherein the gelatin art creation component is securely attached to the needle component.

2. The tool of claim 1, wherein the gelatin art creation component comprises a stainless steel component.

3. The tool of claim 1, wherein the gelatin art creation component is soldered to the needle component.

4. The tool of claim 1, wherein the needle component comprises a hydroponic needle.

5. The tool of claim 1, wherein the needle component is further attached to a syringe.

6. The tool of claim 5, wherein the syringe is selected from the group consisting of a monoject syringe and a luer lock disposable syringe.

7. The tool of claim 1, wherein the needle component is further attached to a leur lock bottle.

8. The tool of claim 1, wherein the gelatin art creation component comprises stainless steel.

9. A process for making the tool of claim 1, comprising shaping the gelatin art creation component into a shape; and attaching said gelatin art creation component to said needle component.

10. The process of claim 9, wherein said attaching comprises soldering said gelatin art creation component to said needle component.

11. The process of claim 9, further comprising polishing the gelatin art creation component.

12. A method of producing edible gelatin art, comprising use of the tool according to claim 1.

13. The method of claim 12, wherein the edible gelatin art comprises three-dimensional colored shapes using clear or substantially clear gelatin.

14. The method of claim 12, wherein the edible gelatin art is enhanced with different flavors.
